(19) United States
(12) Patent Application Publication
(10) Pub. No.: US 2024/0277011 A1
(43) Pub. Date: Aug. 22, 2024

(54) STARCH-BASED CLOUDING EMULSION AND SPRAY-DRIED STARCH-BASED CLOUDING AGENT FOR BEVERAGES

(71) Applicant: Symrise AG, Holzminden (DE)

(72) Inventors: Dieter Kumlehn, Holzminden (DE); Alexander Diring, Nazareth, PA (US); Christopher Sabater, Holzminden (DE)

(21) Appl. No.: 18/025,333

(22) PCT Filed: Mar. 11, 2021
(86) PCT No.: PCT/EP2021/056222

§ 371 Date: Mar. 8, 2023

Related U.S. Application Data
(60) Provisional application No. 63/079,342, filed on Sep. 16, 2020.

(51) Int. Cl. A23L 2/62; A23L 2/39; A23L 29/212

(52) U.S. Cl. CPC A23L 2/62; A23L 2/39; A23L 29/212

(57) ABSTRACT

The present invention relates to the field of dry beverage mixtures or fluid beverage preparations. More specifically, the present invention describes a novel starch-based clouding emulsion for the preparation of such beverages. Furthermore, a method for preparing a spray-dried starch-based clouding agent as well as the spray-dried starch-based clouding agent obtained according to said method are disclosed. Moreover, the present invention relates to the use of the starch-based clouding emulsion or the spray-dried starch-based clouding agent for the preparation of dry beverage mixtures or fluid beverages. Lastly, the present invention relates to the corresponding dry beverage mixtures or fluid beverages comprising the starch-based clouding emulsion or spray-dried starch-based clouding agent.

### TECHNICAL FIELD OF THE INVENTION

The present invention relates to the field of dry beverage mixtures or fluid beverage preparations. More specifically, the present invention describes a novel starch-based clouding emulsion for the preparation of such beverages. Furthermore, a method for preparing a spray-dried starch-based clouding agent as well as the spray-dried starch-based clouding agent obtained according to said method are disclosed. Moreover, the present invention relates to the use of the starch-based clouding emulsion or the spray-dried starch-based clouding agent for the preparation of dry beverage mixtures or fluid beverages. Lastly, the present invention relates to the corresponding dry beverage mixtures or fluid beverages comprising the starch-based clouding emulsion or spray-dried starch-based clouding agent.

### BACKGROUND ART OF THE INVENTION

In order to simulate the sensory and visual properties of fruit juices and especially cloudy fruit juices, in the last years several attempts have been made to optimize the characteristic mouthfeel, cloudiness, color and of course the taste in the production of artificial juices or those having only a low fruit content, in such a way that these products closely resemble natural fresh pressed fruit juices in appearance and texture, i.e. mouthfeel, by making these beverage preparations appear more cloudy, and thus more natural-looking and feeling, i.e. authentic. Thus, the beverage to be produce from an instant dry beverage mixture or a beverage having a low fruit content should not only resemble the properties of a natural or fresh-pressed fruit juice in terms of its taste and visual appearance such as color and cloudiness, i.e. opalescence or turbidity, but also simultaneously in terms of its mouthfeel or texture. It has been shown that these properties can be imitated particularly well using a so-called ‘clouding agent’ or ‘cloudifier’, which can have a decisive influence on the cloudiness as well as the viscosity or texture and thus the mouthfeel of such artificial beverage preparations. Generally, clouding agents are food additives, which aim at enhancing the turbidity or opacity, i.e. the cloudiness of beverage preparations.

The turbidity of a transparent liquid is generally a subjective optical impression, which is caused by light refraction/scattering at small particles floating within the liquid and having different refractive index from that of the carrier material or which cause absorption, while opalescence describes the iridescence caused by scattering and/or interference of light at small structures in the liquid. However, both phenomena influence the cloudiness of a liquid and thus the visual appearance of a final beverage preparation. Thereby, the turbidity is generally influenced by the number of particles, their size as well as the difference in refractive index between the particles and the matrix.

Especially in the formulation of dry (instant) beverage mixtures for the preparation of artificial fruit juices or other beverages such clouding agents are required, in order to make the final beverage product appear more natural and thus more appealing by influencing its mouthfeel or texture and visual appearance by adjusting the cloudiness (turbidity/opalescence) of the resulting fluid beverage preparation.

Thereby these clouding agents have to be rather neutral in taste and odor and simultaneously exhibit a certain stability when redissolved with water without settling to the bottom or floating on top of the as-prepared drink up at least up to consumption. In addition, when used as powdered clouding product, especially a high storage stability is desired. Moreover, a powdered beverage mixture should efficiently, i.e. instantaneously and completely dissolve in the liquid medium used for the preparation of the fluid ready-to-drink beverage product.

Oil-in-water emulsions are normally used to generate the desired cloudiness. However, to avoid a floating of the oil-based particles on top of the beverage preparation due to the lower density compared to water, often so-called weighting agents (or density-adjusting agents) are added to the clouding formulation such as brominated vegetable oil, sucrose acetate isobutyrate (SAIB), ester gum, and damar gum. However, those substances are considered generally rather critical due to their perceived health risk and chemical reactivity. Furthermore, these substances often can cause accumulation of the clouding agent and thus a sedimentation of the cloudifier at the bottom of the beverage preparation.

Commonly titanium dioxide based (TiO₂) clouding agents were used for this purposed due to their excellent clouding properties, high stability and low price.

In U.S. Pat. No. 3,658,552 A it has been described that the degree of opacity possible using a fat-gum system is generally limited and that the incorporation of high levels of clouding agent is costly and may lead to storage stability problems of the fat phase. Moreover, U.S. Pat. No. 3,658,552 A explains that in attempting to simulate the very opaque natural appearance of some juices it is necessary to incorporate such high levels of the clouding agent so that the high fat and gum contents of the cloud result in an undesirable mouthfeel or texture in the beverage upon consumption. Based on this observation U.S. Pat. No. 3,658,552 A discloses a dry cloud material for dry beverage mixes comprising a matrix of water soluble gum having dispersed phases therein of discrete particles of plastic fat and finely ground particles of an inorganic pigment, wherein the pigment is titanium dioxide (TiO₂).

In U.S. Pat. No. 4,187,326 A fat-free TiO₂-based clouding agents are disclosed which are obtained by drying an aqueous dispersion comprised of, on a dry basis, a major amount of maltodextrin (in solution) and minor amounts of xanthan gum and titanium dioxide.

In both publications, the clouding effects obtained could be primarily attributed to the use of titanium dioxide in the respective clouding formulation, so that TiO₂ is an essential ingredient of these clouding agents.

However, it was found that these TiO₂-based food additives, coded as E 171, which for example are added in form of emulsions to beverage preparations, may be harmful due to the relatively small size of the TiO₂ particles contained therein: It was found that food grade TiO₂ usually has a particle size of around 200 nm in diameter, but it cannot be ruled out that it may contains a certain, non-negligible proportion of particles with even smaller diameters (<100 nm in size), so-called nanoparticles, in amounts of up to 5 wt.-% or even more which might be more reactive than the larger particles or which might even accumulate in the body more easily and thus be harmful to the environment and/or human body. In order exclude any potential health risks, in 2004 the European Food Safety Agency (EFSA) analyzed the influence of these nanoparticles. However, the analysis could not clearly indicate a health risk for consumers. Since then several studies were carried out on this topics questioning the safety of food grade TiO₂, with some of them indeed indicating the potential harm of TiO₂-nanoparticles, for example by having adverse effects on the reproductive system, being accumulated in the spleen or causing cancer. For this reason, recently, several companies have banned the use of food grade TiO₂ or some countries have even prohibited the use of titanium dioxide in beverages. Due to the considerable uncertainties on the toxicity of food grade TiO₂, there is big interest in the food industry for safe and still efficient alternatives to E 171.

Moreover, beverages that contain the inorganic material titanium dioxide as opacifiers regularly have only a low stability of the clouding effect and sedimentation occurs quite quickly. However, the mouthfeel and cloudiness achieved by the cloudifier should be stable and remain at least until consumption. Additionally, the cloudifier has to be stable until reconstitution with water, i.e. has to exhibit a high storage stability (so-called shelf life), especially in powdered form, without losing its properties or causing a change in taste, texture or color in order to achieve a high quality final liquid beverage preparation. Consequently, especially the clouding agent must be highly stable.

First, efforts in providing TiO₂-free clouding agents are described in US 2016/0174598 A1. Therein, a starch-based powdered clouding agent is described which consists essentially of retrograded maltodextrin and is substantially free of titanium dioxide and gum. Thereby, the opacity of the reconstituted beverages is highly dependent on the chain length of the maltodextrin of the clouding agent as well as the type of starch used as the clouding agent so that selection of starch type and dextrose equivalency (DE) value was critical in achieving the desired opacity. Furthermore, in US 2016/0174598 A1 it was found that the starch-based clouding agents generally need to be retrograded and exhibit a specific dextrose equivalent (DE) to function as a clouding agent substantially free of titanium dioxide in powdered beverage mixes. However, the availability of suitable maltodextrins is very limited, as the supply of these maltodextrins requires the fulfilment of numerous parameters as well as a complicated selection and preparation process causing rather high costs. Furthermore, it was described that, after being reconstituted with water, the retrograded starch-based clouding agent may have faster settling rates than a conventional titanium dioxide clouding agent provided at the same amount by weight.

Another attempt at producing a TiO₂-free clouding agent was set out in U.S. Pat. No. 3,023,106 A. U.S. Pat. No. 3,023,106 A discloses a dried emulsion of a homogenized plastic fat coated with a water-soluble gum, thereby the fat being present in a minor proportion and the gum being present in a major proportion, and additionally comprising tricalcium phosphate, as the clouding agent. However, the high amount of the gum and fat-components will likely negatively influence the mouthfeel, the taste and texture of the final beverage preparation upon reconstitution (see above).

The primarily object of the present invention is, therefore, to provide for new clouding agents suitable to efficiently mimic the characteristic mouthfeel, opacity and turbidity of natural fruit juices, which do not rise any health concerns and are highly stable, as well as a method to obtain these new clouding agents.

More specific, it is a major object of the present invention to provide for an efficient clouding agent which is capable of achieving an opalescence and turbidity, or generally cloudy appearance, texture and mouthfeel in liquid beverage preparations which is comparable to those of natural fruit products. Consequently, it is a further object of the present invention to provide for a fluid beverage preparation or dry beverage mixture for preparation of a fluid beverage preparation exhibiting a natural-like cloudy appearance, texture and mouthfeel.

Moreover, it is required that the clouding agent exhibits a high storage stability, especially in dry form for storage reasons as well as a sufficient stability within the final beverage preparation up to consumption. However, especially important is a high storage stability of the cloudifier as such as most dry beverage preparations are consumed directly or shortly after reconstitution with water.

It is a further object of the present invention to provide for an highly efficient cloudifier, capable of achieving an intense and homogeneous clouding effect at low concentrations, simultaneously positively influencing the mouthfeel and texture as well as the visual appearance of the final fluid beverage preparation in order to reduce the overall costs such as for transportation and storage as well as the total amount of required ingredients and additives which might negatively influence the tolerability and/or taste of the final beverage product.

Additionally, it is thus a further object to provide for a product based on fully natural ingredients which do not give rise to any health concerns and which in addition do not cause any off-taste or interaction with other ingredients of the dry beverage mixture.

### SUMMARY OF THE INVENTION

The problems identified above relating to the present invention are solved by a starch-based clouding emulsion according to claim 1 having improved opacity, turbidity, and stability and which is prepared based on fully natural and completely health safe ingredients. Thus, in accordance with a first aspect of the present invention a starch-based clouding emulsion suitable for the preparation of beverage products is described. Preferred embodiments and variants thereof are provided in the corresponding dependent claims as well as the subsequent description.

More specifically, in a first aspect, the present invention relates to a starch-based clouding emulsion suitable for achieving a clouding effect in beverages and thus suitable for use in the preparation of beverage products, the starch-based clouding emulsion comprising or consisting of:
(a) 5 wt.-% to 60 wt.-% of a water-dispersible starch-component;
(b) 0.1 wt.-% to 5 wt.-% of a water-soluble gum-component;
(c) 0.1 wt.-% to 5 wt.-% of an oil-based clouding component;
based on the total weight of the starch-based clouding emulsion; and
(d) water totaling the percentages of all ingredients to 100 wt.-%;
wherein the ratio of the starch-component to the gum-component is higher than or equal to 12:1; and
wherein the ratio of the starch-component to the oil-based clouding component is higher than or equal to 12:1.

In a second aspect, the present invention relates to a method for preparing a spray-dried starch-based clouding agent comprising the following steps:
(i) preparation of a starch-based clouding emulsion by:
(i-i) providing an aqueous phase by mixing and dispersing 5 wt.-% to 60 wt.-% of a water-dispersible starch-component and 0.1 wt.-% to 10 wt.-% of a water-soluble gum-component in an aqueous solution (based on the total weight of the starch-based clouding emulsion);
(i-ii) providing 0.1 wt.-% to 10 wt.-% of an oily phase comprising or consisting of an oil-based clouding component (based on the total weight of the starch-based clouding emulsion); and
(i-iii) emulsifying the aqueous phase and the oily phase to obtain an oil-in-water emulsion; and
(ii) spray-drying the as-prepared oil-in-water emulsion in order to obtain a powdered spray-dried starch-based clouding agent.

The invention thus further encompasses in a third aspect a spray-dried starch-based clouding agent obtainable according to the method of the second aspect.

In another aspect, the present invention also relates to the use of the starch-based clouding emulsion or the spray-dried starch-based clouding agent for the preparation of beverage products such as dry beverage mixtures or fluid beverage preparations.

Therefore, finally, a fifth aspect of the present invention relates to dry beverage mixtures or fluid beverages comprising the starch-based clouding emulsion or spray-dried starch-based clouding agent described herein.

Surprisingly, it was now found that these starch-based clouding emulsions or spray-dried starch-based clouding agents prepared from said emulsion make the final liquid beverage preparations appear more appealing, i.e. more natural-looking, and generate a more pleasant mouthfeel, closely imitating the visual appearance and sensorial texture of natural fruit juices, when added to fluid beverages or instant dry beverage formulations which are mixed with water, or other suitable liquids, to form the final fluid beverage product ready for consumption. Thereby these clouding substances do not settle or only settle very little in the final liquid beverage preparation up to consumption while simultaneously a high degree of turbidity and opalescence is achieved, i.e. the clouding emulsion and the powdered clouding agent exhibit excellent cloudifying properties even when used in small amounts. Consequently, only small amounts are required to achieve a strong opalescent effect and a relatively high turbidity further reducing costs and the total amount of additives required in the final liquid beverage preparation in order to imitate fresh natural juices rich in fruit content, especially since customers recently have developed a more nature-based consumption pattern. The starch-based clouding emulsion and thus the spray-dried starch-based clouding agent according to the invention are able to efficiently mimic the visual opalescence and turbidity inherent to natural fruit juices in an efficient manner in artificial fruit juices, soft drinks or other beverages based on powdered beverage formulations as well as beverages only having a low fruit juice content, such as common soft drinks with low fruit juice content. Furthermore, it was possible to provide for a highly stable clouding agent especially stable in dry powdered beverage formulations to give the desired opacity and turbidity of natural fruit juice while simultaneously providing an authentic mouthfeel when reconstituted to form a fluid beverage preparation upon addition of water closely resembling the sensory and visual properties of natural fruit juices rich in juice content. Moreover, the inventive spray-dried clouding agent can efficiently be formulated directly into fluid beverage preparations to achieve a natural-looking and appealing effect in those fluid beverages, for example into soft drinks having a relatively low fruit juice content or clear fruit juices to mimic a freshly pressed natural-cloudy/unfiltered fruit juice rich in fruit content. Due to the low fat content the clouding agent exhibits excellent stability in powdered form not showing any phase separation of the fat component or rancidity caused by oxidation thus not resulting in an unpleasant off-taste, texture or mouthfeel or clumping in the final liquid beverage preparation or the powdered clouding agent, respectively. In addition, the as-obtained clouding agent is able to instantaneously and homogeneously dissolve within the final liquid beverage preparation.

The invention is specified in more detail in the corresponding claims. The inventive clouding preparation, and preferred variants thereof, and further advantages of the present invention, are also apparent from the following detailed description in conjunction with the accompanying examples and figures.

### FIGURES

FIG. 1 shows the particle size distribution of a starch-based clouding emulsion according to the first aspect prior to spray-drying.

FIG. 2 shows the particle size distribution of a spray-dried TiO₂-based clouding agent.

FIG. 3 shows the particle size distribution of a spray-dried starch-based clouding agent according to the second and third aspect.

FIG. 4 shows the relationship between turbidity and oil droplet size (clouding effect).

FIG. 5 shows the particle size distribution of spray-dried starch-based clouding agents in different concentrations in comparison with Comparative Samples each in ready to drink (RTD) beverage preparations.

FIG. 6 shows the turbidity of spray-dried starch-based clouding agents in different concentrations in comparison with Comparative Samples each in ready to drink (RTD) beverage preparations.

### DETAILED DESCRIPTION OF THE INVENTION

In a first aspect, the present invention relates to a starch-based clouding emulsion comprising or consisting of:
(a) 5 wt.-% to 60 wt.-% of a water-dispersible starch-component;
(b) 0.1 wt.-% to 5 wt.-% of a water-soluble gum-component;
(c) 0.1 wt.-% to 5 wt.-% of an oil-based clouding component;
each based on the total weight of the starch-based clouding emulsion; and
(d) water totaling the percentages of all ingredients to 100 wt.-%;
wherein the ratio of the starch-component to the gum-component is higher than or equal to 12:1; and
wherein the ratio of the starch-component to the oil-based clouding component is higher than or equal to 12:1.

Generally, the clouding substance according to the invention can be added to a fluid beverage in liquid form, as the clouding emulsion, or in powdered form thereof, as a spray-dried clouding agent. However, preferably the powdered spray-dried clouding agent is used. Alternatively, the spray-dried clouding agent can be added to a dry beverage formulation which can be reconstituted with water to form a fluid beverage preparation.

Emulsions are mixtures of two immiscible liquids, one of them being dispersed in the other liquid in the form of fine droplets. Generally, such systems are homogenous, transparent and milky in color. As with all emulsions, one phase serves as the dispersing agent. This is often called the continuous or outer phase or matrix. The remaining phase is called the dispersed or inner phase, because the liquid droplets are finely distributed amongst the larger continuous-phase droplets. Emulsions, comprising two phases, can be subdivided into two different types: In an oil-in-water (O/W) emulsion, oil droplets are dispersed in water. This is the most common type of emulsion. Conversely, a water-in-oil (W/O) emulsion involves water droplets finely dispersed in oil. Within the context of the present invention, the starch-based clouding emulsion is an oil-in-water (O/W) emulsion in which the oily phase (oil-based clouding component) is dispersed in an aqueous phase, preferably pure water.

The first component, constituting the aqueous or continuous or outer phase and thus the matrix of the oil-in-water starch-based clouding emulsion of the present invention is water or alternatively water in combination with a polar solvent, miscible in water, but immiscible in the oily phase as well as other water-soluble components. Preferably, the aqueous phase of the oil-in-water clouding emulsion of the present invention comprises a water-dispersible starch-component as well as a water-soluble gum-component dissolved in pure water.

The starch-based clouding emulsion according to the first aspect, and in particular the spray-dried starch-based clouding agent obtainable from said emulsion are meant to efficiently cause a cloudification in beverage products with low fruit content or those prepared from dry beverage formulations to authentically mimic the appearance and texture of actual fruit juices rich in fruit content. The cloudiness is defined by the turbidity as well as the opacity of the beverage, whereby the incorporation of the inventive cloudifiers causes a change in the light transmittance, resulting in an increased cloudiness closely resembling the appearance of natural fruit juices. Additionally, the cloudifiers cause a positive change in texture and thus in mouthfeel being very similar to those of natural fruit juice products. Thereby, it was surprisingly found that neither the taste nor the stability of the powdered beverage formulations are negatively influenced.

Suitable starch-components used for this purpose are water-dispersible and organic in nature, for example native starch or modified natural starch, so called modified starch, conventionally used for food products, i.e. edible starch products. Natural starch sources are for example rice, corn (maize), waxy maize, wheat, barley, potatoes, sweet potatoes, cassava, tapioca or the like as well as the mixtures thereof. In addition, it is possible to use starch preparations and starch products other than those specified above, for example degraded starch, aldehyde starches etc. Modified starches suitable for the preparation of the starch-based clouding emulsion are starches which are physically, chemically or enzymatically modified by pre-gelatinization, dextrinization, derivatization, cross-linking and the like such as pregelatinized or hydrolyzed starch. However, preference is given to using native starch, and preferably native rice starch, in the preparation of the starch-based clouding emulsion according to the invention. However, native starches from any of the above natural sources as well as their mixtures are suitable and preferred for the purpose of the present invention. Thus, the starch-component is preferably a starch or starch mixture/blend from one or more of the above sources. Moreover, it is important that the used starch shows good dispersibility in aqueous media in order to achieve a homogeneous particle formation and distribution and thus a homogeneous and intense clouding effect. Furthermore, preferably the starch used within the scope of the present invention is untreated and thus not modified in any way. This allows for the starch to be classified as foodstuff and hence an ingredient rather than a food additive classified with a so called “E” label. This is preferred in view of the public's growing demand for natural and organic foods in general. In addition, native starches show excellent thickening, gelling, texturizing and stabilizing properties. Consequently, a natural-based product can be achieved giving no rise to any health concerns. Therefore, the starch-component is preferably organic native starch, and even more preferred native rice starch, or a blend of native starches.

By using native starches, such as native rice starch or blends of native starches, the organic and healthy aspect of the present cloudifiers is underlined which is in line with the recently arising “clean label” or “clean eating” trend, i.e. the desire for healthy food that is prepared in a purely natural way and foods containing rather natural and unprocessed ingredients as healthier alternative and hence the desires for products with a reduced number of additives and thus “E”-numbers. Moreover, organic native starch is free of gluten and thus suitable for a gluten-free diet. Additionally, native starches are cheap and available in high amounts. Furthermore, best clouding efficiencies were found for those compounds.

Therefore, in a preferred variant, the water-dispersible starch-component of the starch-based clouding emulsion according to the invention is native rice starch.

Furthermore, the average particle size of the starch used within the scope of the present invention ranges from 1.0 μm to 270.0 μm. Higher or lower particle sizes might negatively influence the emulsification process and consequently the particle sizes within the clouding products as well as the beverage preparations, resulting in lower efficiencies and stabilities which in turn might affect the mouthfeel, taste and opacity/turbidity.

In contrast to previous publications these starch preparations or products used within the scope of the present invention do not need to be retrograded to function as a clouding agent or modified in any other way. The starch used within the scope of the present invention is not swollen so that no recrystallization is necessary, i.e. no retrogradation of the starch-component is required. It should be noted that retrograded starch is rather less digestible than unprocessed native starch. Commercially available and in particular organic native starch products and preparation such as blends of native starches are suitable for the preparation of the starch-based clouding emulsion or the spray-dried starch-based clouding agent according to the invention and make it possible to meet the consumer demand for healthier alternatives and simultaneously allowing for a reduction of the carbon footprint due to a reduced amount of chemicals end energy required to provide for the starting material, i.e. the starch-component. However, also starch-components or matrix former such as maltodextrins of different DE values can also be used within the context of the present invention.

Additionally, the aqueous phase of the starch-based clouding emulsion comprises a water-soluble gum-component simultaneously acting as emulsifying and stabilizing agent. Preferably also the gum-component is of natural origin (organic), preferably plant-based, and edible. Suitable water-soluble gum-components are for example locust bean gum (carob seeds), guar gum, flaxseed gum, gum tragacanth, gum ghatti, gum karaya, gellan gum, konjac gum, welan gum, agar-agar, xanthan gum, cellulose gum (carboxymethyl cellulose; CMC) and the like or mixtures thereof. However, preferably the gum-component is gum arabic such as type seyal, type senegal, type eficacia, modified gum arabic and the like or mixtures thereof as it is essentially tasteless and generally considered safe for ingestion.

Therefore, a preferred variant of the present invention relates to a starch-based clouding emulsion, wherein the water-soluble gum-component is gum arabic.

In addition, the amount of the gum-component used influences the stability of the clouding agent within the final beverage preparation. However, if the amount of the gum-component is within the ranges specified herein, best stabilities are achieved up to consumption of the beverage without aggregation of the agent on the bottom of the beverage preparation or floating on its surface.

The hydrophobic component, i.e. the oily phase comprises or consists of an oil-based clouding component which must be edible and is preferably of natural origin. Specific non-limiting examples of such oil-based clouding components include for example triglycerides in general and oils extracted from plants like vegetable oils, such as corn oil, sunflower oil, soybean oil, safflower oil, coconut oil, palm oil, peanut oil, orange oil, rapeseed oil, palm kernel oil, cotton seed oil, olive oil, rice bran oil, shea butter or the like and mixtures thereof. In view of the present invention, however, generally untreated plant-based oils are preferred in order to meet the consumer demand for healthier products and reduce environmental issues. Furthermore, in particular, aromatic oils having a specific flavor such as citrus oils are suitable for simultaneously modelling the aroma of the final beverage while additionally reducing the overall amount of different ingredients required for the preparation of the final beverage product. However, by selecting an oily component which is neutral in taste, it is possible to provide for a clouding product which is universally applicable in all kinds of beverages, regardless of the aroma to be achieved. Therefore, also medium-chain triglycerides, so-called MCTs or oleum neutrale, a type of vegetable oil obtainable by hydrolysis of natural oils and subsequent esterification with glycerol or by simple fractionation from oils such as palm kernel oil, coconut oil and the like, are also suitable due to their nearly colorless to slight yellowish color, neutrality in odor and taste as well as their health benefits.

Preferably, the oil-based clouding component constituting the oily phase of the oil-in-water clouding emulsion of the present invention is an organic vegetable oil neutral in color, taste and odor or is an MCT oil obtained from an organic vegetable oil in order to avoid off-tastes and the like. Those substances are considered best based on efficiency, stability and taste and the possibility to incorporate those ingredients in various beverage formulations irrespective of its final aroma, providing for a universally applicable clouding tool.

Thus, in one specifically preferred variant, a starch-based clouding emulsion is disclosed, wherein the oil-based clouding component is a natural vegetable oil or a modified vegetable oil such as an MCT oil.

The proportion of the water-dispersible starch-component used in the context of the present invention is 5 wt.-% to 60 wt.-% relative to the total weight of the oil-in-water starch-based clouding emulsion. However, the water-dispersible starch-component is preferably comprised in an amount ranging from 10 wt.-% to 50 wt.-%, more preferred from 20 wt.-% to 45 wt.-% and even more preferred in an amount of 30 wt.-% to 40 wt.-%. Most preferred the amount of the water-dispersible starch-component relative to the total weight of the starch-based clouding emulsion is 35 wt.-%.

Moreover, the amount the water-soluble gum-component is ranging from 0.1 wt.-% to 5 wt.-% relative to the total weight of the starch-based clouding emulsion. However, preferably the water-soluble gum-component is comprised in an amount of 0.1 wt.-% to 2.5 wt.-% and more preferred in an amount of less than 1 wt.-% based on the total weight of the starch-based clouding emulsion. Particularly preferred the amount of the water-soluble gum-component is about 0.5 wt.-% relative to the total weight of the starch-based clouding emulsion.

Furthermore, the oil-based clouding component is comprised in an amount 0.1 wt.-% to 5 wt.-% relative to the total weight of the starch-based clouding emulsion and preferably in an amount ranging from 0.1 wt.-% to 2.5 wt.-%, more preferred in an amount of less than 1 wt.-% and even more preferred the proportion of the oil-based clouding component is 0.5 wt.-% relative to the total weight of the starch-based clouding emulsion.

Thereby the portion of the starch-component to the gum-component within the starch-based clouding emulsion according to the invention is preferably higher than or equal to 12:1, although the ratio of the starch-component to the gum-component is preferably considerably higher such as preferably ranging between 30:1 to 85:1 and more preferred between 50:1 and 80:1.

Consequently, the water-soluble gum-component, which is gum arabic, gum tragacanth, gum acaria and the like, is present only in a very small proportion relative to the starch-based component in the finished clouding emulsion and thus also in the powdered spray-dried starch-based clouding agent prepared from said emulsion in turn resulting in only extremely low amounts of gum in the final beverage product.

Simultaneously, the proportion of the starch-component relative to the oily or dispersed phase, i.e. the oil-based clouding component of the starch-based clouding emulsion is preferably at least 12:1. This means the ratio of the starch-component to the oil-based clouding component is higher than or equal to 12:1. However, preferably the ratio of the starch-component to the oil-based clouding component is between 30:1 to 85:1 and more preferred between 50:1 and 80:1 within the starch-based clouding emulsion according to the invention. Consequently, in the final beverage preparation also the amount of the oily component is also very low.

If the contents of the single components of the starch-based clouding emulsion, i.e. the contents of the water-dispersible starch-component, the water-soluble gum-component and the oily phase are within the ranges specified above, a highly stable and efficient spray-dried clouding agent can be provided. Furthermore, for those ratios, the best combination of properties and characteristics, particularly regarding cloudiness, taste, mouthfeel (texture) and stability have been found. Due to the low-fat component no phase separation, oxidation or clumping of the powdered clouding agent obtainable form the above emulsion is observed resulting in a long shelf storage lifetime without changes in taste, color, or clouding efficiency. Furthermore, good reconstitution with water or other suitable liquids is guaranteed. In addition, the low gum amounts do not negatively influence the texture or mouthfeel of the final liquid beverage preparation.

Furthermore, if the proportions fall within the above ranges, reconstitution with water, i.e. the redissolution by addition of water or another suitable liquid to form the final fluid beverage preparation ready for drinking will be efficient by allowing for a discrete, instantaneous and homogeneous release and spread of the single small-sized oil-particles to form a stable and homogeneous oil-in-water emulsion within the final beverage preparation with intense cloudiness for at least 24 hours up to consumption without settling due to aggregation or the like or floating on the surface of the beverage preparation due to phase separation etc.

A starch-based clouding emulsion and the spray-dried starch-based clouding agent prepared from said emulsion create an especially pronounced opacity and turbidity resulting in efficient clouding properties, i.e. causing high opalescence and turbidity in beverage preparation while only requiring little amounts of the corresponding cloudifier.

Normally, as indicated above, when using oil-in-water emulsions as clouding agents for beverages, it is necessary to incorporate high amounts of said clouding agents in order to achieve the desired clouding effect due to their relatively low degree of opacity. Moreover, the portions of the gum-component and oil-component are usually considerably higher in those clouding agents of the state of the art resulting in an undesirable mouthfeel and taste in the final beverage product as well as reduced stability due to a separation of the oily component.

However, the starch-based clouding emulsion disclosed herein as well as the spray-dried starch-based clouding agent prepared based on said emulsion surprisingly allow for achieving a highly cloudy (opaque and turbid), but natural and thus authentic appearance and texture of the final beverage preparation closely resembling the appearance and texture (mouthfeel) of natural fruit juices rich in fruit content, i.e. not negatively affecting either the taste nor the mouthfeel of the beverage. Moreover, the clouding products according to the invention, i.e. the starch-based clouding emulsion or the powdered spray-dried starch-based clouding agent, surprisingly show a high opalescence and turbidity even when used in relatively small amounts allowing for a significant reduction of the cloudifier required to obtain a certain degree of clouding. Additionally, due to the small amounts of the clouding emulsion/agent required as well as the low oil and gum portions contained therein neither the mouthfeel nor the taste are negatively influenced and a relatively high stability of the beverage preparation after redissolution of a dry beverage formulation containing said clouding agent with water, and in particular of the spray-dried clouding agent as such can be guaranteed.

Therefore, additionally the clouding emulsion and agent according to the invention reduce the problems related to the storage stability of the fat phase of the oil-in-water system. As most beverage preparations are meant to be consumed shortly after reconstitution with water, especially the storage stability of the powdered clouding agent is decisive. It was surprisingly found that the present clouding products allow for a considerable long-term storage due to the remarkable stability of the powdered clouding agent, i.e. the spray-dried starch-based clouding agent, not showing a segregation of the oily phase and thus achieving consistent quality in view of clouding properties, taste and texture within the final fluid beverage preparation.

Additionally, preferably, the ratio of the gum-component to the oil-component ranges between 0.5:1 and 1:0.5. However, preferably the gum to oil ratio is about 1:1 resulting in the most satisfying opacities, turbidities, mouthfeel, and stability.

Therefore, in a further preferred variant of the present invention, the proportion of the gum-component relative to the oily or dispersed phase, i.e. the oil-based clouding component of the starch-based clouding emulsion, is about 1:1.

Furthermore, in a preferred first variation of the first aspect, the starch-based clouding emulsion according to the invention preferably has a viscosity in the range of 5 mPa·s to 500 mPa·s, more preferred from 50 mPa·s to 250 mPa·s, and even more preferred from 100 mPa·s to 150 mPa·s. Such viscosities of the initial clouding emulsion allow for an enhanced processability to form the corresponding spray-dried clouding agent with homogeneous particle size distribution resulting in a homogeneous dispersion of discrete oil particles within the final liquid beverage preparation. Moreover, clumping is avoided upon spray-drying so that a homogenous and stable powdered clouding agent is achieved.

As indicated above, commonly used weighting agents are considered generally rather critical in view of stability and health issues. However, if the content of the ingredients of the clouding emulsion and thus the spray-dried clouding agent, respectively, is within the preferred ranges and ratios, it is possible to achieve a highly stable clouding agent capable of producing a highly stable, intense and homogenous but natural-like clouding effect (turbidity/opalescence) in terms of appearance and texture, wherein the cloudifier neither does accumulate or settle at the bottom of the beverage preparation after redissolution nor does float on the final beverage preparation for at least 24 hours, without the requirement of adding a weighting agent or other emulsification enhancers to the inventive clouding formulation. Moreover, the powdered spray-dried clouding agent exhibits a long shelf-store lifetime of at least two years. Thereby, the total amount of additional and possibly non-natural and rather unhealthy ingredients can be reduced to meet the consumer demand and simultaneously the overall production costs due to a reduces number of chemicals and procedural steps required in total to provide for the components of the emulsion/agent and the final clouding agent as such.

Therefore, a preferred variant of the present invention refers to a starch-based clouding emulsion, which does not additionally comprise a weighting agent.

More specifically, the present invention relates to a starch-based clouding emulsion, wherein generally no additional ingredients are present at all within the formulation of the starch-based clouding emulsion except those specified in the first aspect. Consequently, the starch-based clouding emulsion as such preferably does not contain any other substances such as stabilizers, thickeners or emulsifiers or the like. In addition, weighting agents are generally more susceptible to oxidation, which might cause off-tase in the final beverage product and might additionally reduce the storage stability of the clouding emulsion or agent, respectively.

Based on the composition specified above, it is thus possible to achieve an efficient clouding substance which exhibits an ideal balancing, not requiring additional weighting agents to achieve a stable and homogeneous emulsion within the instantly prepared beverage product up to consumption.

Generally, the main advantage of the present invention is, that the clouding formulation of the present invention surprisingly gives a homogeneous, relatively stable and relatively intense turbidity and opalescence to beverage preparations even when added in relatively low concentrations, i.e. the spray-dried starch-based clouding agent obtainable from said starch-based clouding emulsion is able to efficiently cause clouding in beverage preparations. Moreover, the powdered spray-dried starch-based clouding agent shows high storage stability and is homogenously dispersed within the beverage preparation after redissolution with water or other suitable liquids in form of finely dispersed discrete oil droplets. Therefore, the cloudifier according to the present invention allows, for example, for achieving a very natural and authentic appearance and texture closely imitating the appearance and texture of freshly pressed fruit juices without requiring the incorporating of high amounts or negatively influencing its taste and mouthfeel.

The spray-dried starch-based clouding agent is prepared starting from a corresponding starch-based clouding emulsion specified above. Generally, the spray-dried starch-based clouding agent herein is prepared by forming an emulsion of an oily phase finely dispersed within an aqueous matrix (aqueous phase) comprising or consisting of a water-dispersible starch-component, a water-soluble gum-component and an aqueous solution, and subsequently drying said oil-in-water emulsion as specified above to obtain a fine powder, i.e. the powdered clouding agent.

More specifically, the spray-dried starch-based clouding agent is prepared by providing a starch-based clouding emulsion based on mixing and dissolving 5 wt.-% to 60 wt.-% of a water-dispersible starch-component and 0.1 wt.-% to 10 wt.-% of a water-soluble gum-component in an aqueous solution which is emulsified with 0.1 wt.-% to 10 wt.-% of an oily phase substantially comprising or consisting of an oil-based clouding component to form the starch-based oil-in-water clouding emulsion according to the first aspect of the invention. Thereby, the respective amounts of the components required are based on the total weight of the starch-based clouding emulsion. Subsequently, the as-prepared emulsion is spray-dried to give the final powdered clouding agent exhibiting a homogeneous particle size distribution, long storage stability and high clouding efficiency.

Therefore, in a second aspect, the present invention relates to a method for preparing a spray-dried starch-based clouding agent comprising the following steps:
(i) preparation of a starch-based clouding emulsion by:
(i-i) providing an aqueous phase by mixing and dissolving 5 wt.-% to 60 wt.-% of a water-dispersible starch-component and 0.1 wt.-% to 10 wt.-% of a water-soluble gum-component in an aqueous solution (based on the total weight of the starch-based clouding emulsion);
(i-ii) providing 0.1 wt.-% to 10 wt.-% of an oily phase comprising or consisting of an oil-based clouding component (based on the total weight of the starch-based clouding emulsion);
(i-iii) emulsifying the aqueous phase and the oily phase by dispersing the oily phase in the aqueous phase by stirring, shaking, pressing or otherwise inducing sheer forces, to obtain an oil-in-water emulsion with very discrete oil particles (i.e. the starch-based clouding emulsion according to the first aspect); and
(ii) spray-drying the as-prepared oil-in-water emulsion to obtain a powdered spray-dried starch-based clouding agent, preferably while simultaneously mixing in order to achieve a homogenous particle distribution with appropriate particle sizes.

In accordance with the first aspect of the present invention, the water-dispersible starch-component is added in an amount of 20 wt.-% to 50 wt.-% relative to the total weight of the resulting starch-based clouding emulsion and preferably in an amount ranging from 20 wt.-% to 45 wt.-%, even more preferred from 30 wt.-% to 40 wt.-%.

Thereby, in a preferred variant of the present invention, the water-dispersible starch-component is native rice starch or any other of the suitable starch-components identified above.

The obtained oil-in-water emulsion is preferably converted into a solid powdered composition (the corresponding clouding agent) by spray-drying. However, any conventional technology can be applied to obtain a powdered starch-based clouding agent as such.

Moreover, in order to prepare the spray-dried starch-based clouding agent, it is required that the water-soluble gum-component is added in an amount of 0.1 wt.-% to 5 wt.-% relative to the total weight of the resulting starch-based clouding emulsion, preferably in an amount ranging from 0.1 wt.-% to 2.5 wt.-%, and even more preferred in an amount of less than 1 wt.-%.

Thereby, the water-soluble gum-component can be any of the gum-components identified in accordance with the first aspect of the present invention, but preferably the gum-component is gum arabic.

However, to achieve a homogenous and fine particle distribution responsible for the cloudiness, it is recommended that the water-dispersible starch-component and the water-soluble gum-component are successively mixed and dispersed or dissolved in the aqueous solvent such as pure water.

Therefore, in preferred variant of the present invention the method for preparing a spray-dried starch-based clouding agent requires that the water-dispersible starch-component and the water-soluble gum-component are successively dispersed/dissolved in water. Thereby, the water-dispersible starch-component is first added and mixed in the aqueous solvent which is preferably pure water.

Furthermore, the oil-based clouding component of the oily phase as specified above which is finely dispersed within in the aqueous phase by stirring, shaking, pressing or otherwise inducing sheer forces, to obtain an oil-in-water emulsion, is added in an amount ranging from 0.1 wt.-% to 5 wt.-% relative to the total weight of the resulting starch-based clouding emulsion, and preferably from 0.1 wt.-% to 2.5 wt.-% or even more preferred in an amount of less than 1 wt.-%.

To achieve a product based on fully natural or organic and harmless ingredients which does not negatively influence either the stability, the taste nor odor of the beverage product, the oil-based clouding component is preferably a vegetable oil.

In addition, the strength of the sheer forces induced influences the resulting particle size: In order to obtain a cloudifier which is capable of homogeneously releasing finely dispersed particles in the final liquid beverage preparation, it is required that the initial oil droplets of the clouding emulsion show a narrow, i.e. homogeneous particle size distribution. The influence of the particle size will be explained below.

However, in order to finely disperse the oily phase within the aqueous matrix phase and to achieve an efficient clouding effect, it is the starch-based clouding emulsion is preferably prepared at a stirring or shaking rate of about 500 rpm to 2 000 rpm, in particular about 700 rpm to 1 000 rpm, to achieve the formation of discrete oil droplets having a finer particle size distribution also within the final beverage preparation and thus a homogeneous and relatively stable clouding effect with an homogeneous and appealing appearance and texture.

Furthermore, in order to avoid degradation or structural modification of the ingredients of the starch-based clouding emulsion and the spray-dried starch-based clouding agent, respectively, it is recommended that the temperature of the aqueous phase does not exceed 70° C. Preferably, the temperature of the aqueous phase is kept below 60° C. and more preferred below 50° C. Potential degradation products could interact with the other beverage ingredients or cause a negative off-taste and unpleasant odor as well as a reduced cloudifying efficiency and stability of the cloudifier.

In addition, to prepare a stable and efficient clouding agent it is not required to add any additional substances except those specified in the first and second aspect of the invention as indicated above. Therefore, in a preferred variant of the invention, the method does not include the addition of weighting agents or any other additional ingredients. Additionally, this allows for the total amount of ingredients to be reduced to a few selected natural substances which are neither harmful nor must be (or should be) processed in a special manner prior to the preparation in order to be suitable. Simultaneously the overall costs can be reduced.

Nevertheless, optionally additional stabilizers can be added. For example, 0.02 wt.-% to 0.9 wt.-% of polysaccharides, xanthan gum or carboxymethylcellulose or the like can be added, or 0.03 wt.-% to 0.7 wt.-% locust bean gum or guar gum, and the like or a mixture thereof. However, due to the presence of the gum-component as essential ingredient of the cloudifier, generally no additional stabilizers are required.

Moreover, the invention further encompasses in a third aspect a spray-dried starch-based clouding agent obtained according to the method of the second aspect.

Surprisingly, it was found, that it was possible to easily produce an instant-soluble spray-dried clouding agent, which, after redissolution in water, produces a relatively stable and homogeneous oil-in-water emulsion until consumption. Moreover, the as-obtained powdered clouding agents exhibits a high storage stability, is preferably neutral in taste and odor and highly efficient in view of its clouding properties. Furthermore, the inventive powdered clouding agent is preferably prepared based on fully unprocessed, natural and organic ingredients.

In addition, based on the starch-based clouding emulsion of the first aspect and the method according to the second aspect a spray-dried starch-based clouding agent can be provided in powdered form, which allows to achieve a high degree of cloudiness, i.e. opalescence and turbidity, when added into dry beverage formulations which are subsequently redissolved with water or into already reconstituted fluid beverage preparations with low fruit content or the like to closely resemble the sensory and visual properties such as appearance and texture of natural fruit juices rich in fruit content. Thereby, it was found that only a small amount of the spray-dried starch-based clouding agent is required to achieve a relatively intense clouding effect.

Furthermore, it was found that the spray-dried starch-based clouding agent exhibits a high stability within the dry beverage mixture as well as a sufficient stability within the fluid beverage preparation obtainable after reconstitution with water: The spray-dried starch-based clouding agent does not negatively influence the dry beverage mixture as such, i.e. does not negatively interact with any of the ingredients of the beverage formulation and does not decompose and thus allows for a long storage stability. Moreover, the clouding agent shows a high compatibility with all of the other ingredients of the beverage formulation. In contrast to commercially available clouding agents comprising oil and gum-components, the powdered clouding agent according to the invention is highly stable as no phase separation is observed. Surprisingly, it was found that the present clouding agent is stable for at least two years in powdered form, ensuring consistent quality in terms of appearance (cloudiness), taste and texture upon mixing with water to form the fluid beverage preparation, irrespective of the preceding storage time.

Therefore, it is possible to reduce both storage and transportation costs from manufacturing to selling, for example in a store, as the spray-dried starch-based clouding agent is highly stable, cheap in production, light weighted and highly efficient, i.e. only small amounts of the spray-dried starch-based clouding agent are required in order to achieve a strong clouding effect.

Therefore, the present spray-dried starch-based clouding agent surprisingly provides for a valuable, stable, safe and simultaneously highly efficient alternative to E 171.

It was further surprisingly found, that the present spray-dried starch-based clouding agent is an excellent tool in particular for providing authentic cloudiness to beverage preparations such as artificial fruit juices or those having a low fruit content and thus to authentically simulate the cloudiness inherent in natural fruit juices obtainable directly from fruit products. The clouding agent, according to the present invention, is thus capable of achieving an appearance, texture and mouthfeel in the final beverage preparation, which is comparable to those inherent of natural fruit juice, in terms of appearance as well as mouthfeel.

In particular, the present spray-dried starch-based clouding agent can be prepared from fully natural and organic ingredients not requiring complicated processing and thus not rising any health concerns or additional costs.

Although the starch-based clouding emulsion according to the first aspect can be used as efficient clouding agent also having the advantages identified above, the powdered spray-dried dried starch-based clouding agent shows an even higher degree of stability and is cheaper in view of storage and stability.

Therefore, in preferred variant, the present invention also refers to a spray-dried starch-based clouding agent comprising a water-dispersible starch-component, a water-soluble gum-component, and an oil-based clouding component, wherein the remaining amount of aqueous solvent is less than 5 wt.-% relative to the total amount of the spray-dried starch-based clouding agent.

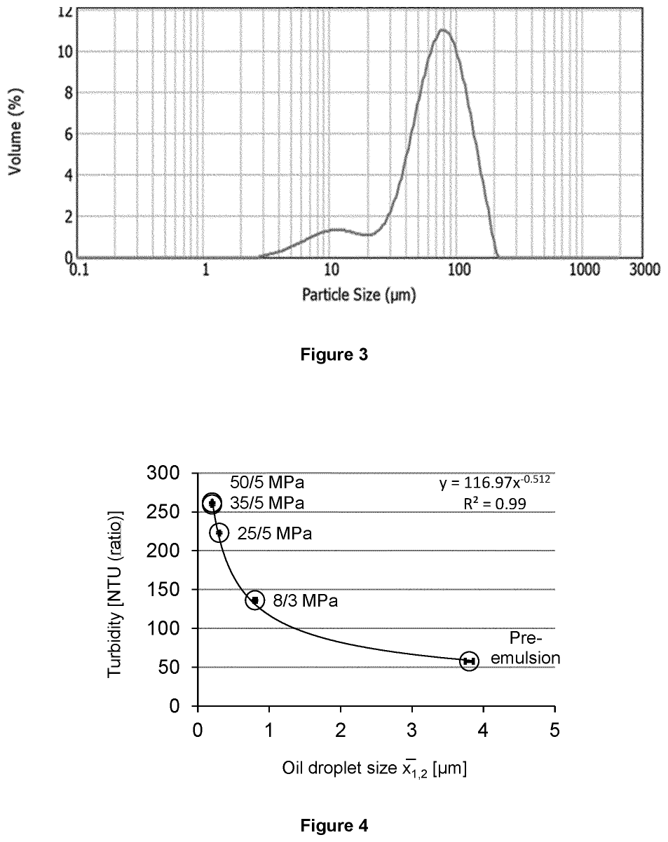

It was found that the spray-dried product preferably has an average particle size of below 100 μm, such as between 10 μm and 100 μm, and more preferred between 10 μm and 90 μm or even more preferred 60 μm and 90 μm and even most preferred between 70 μm and 80 μm. However, best stabilities and redissolution properties were observed for spray-dried starch-based clouding agents having a particle size of approximately 78 μm (FIG. 3).

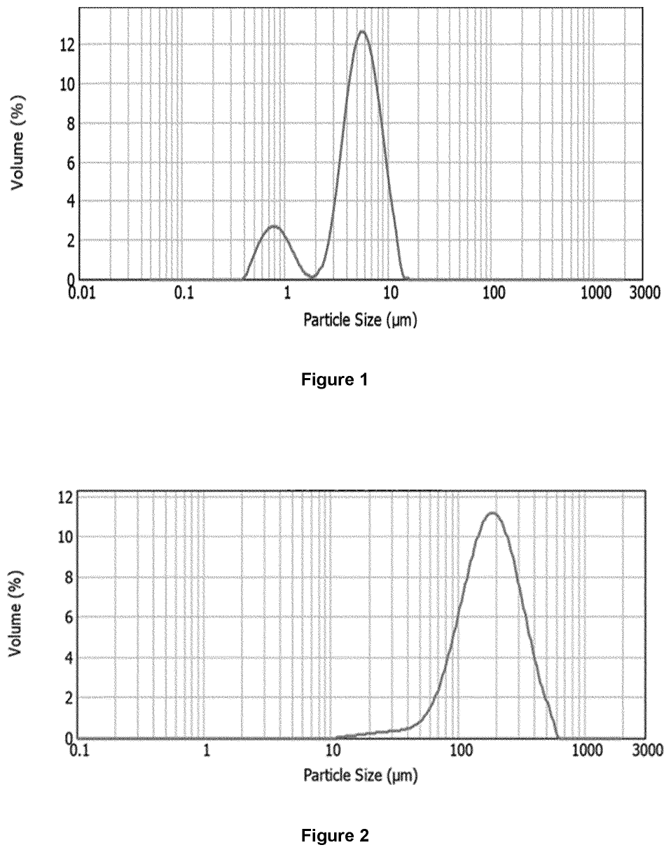

In comparison comparable spray-dried TiO₂-based clouding agents exhibit a mean particle size of approximately 180 μm (FIG. 2).

Therefore, in a preferred variant a spray-dried starch-based clouding agent having an average particle size of 10 to 78 μm, i.e. less than 80 μm is disclosed.

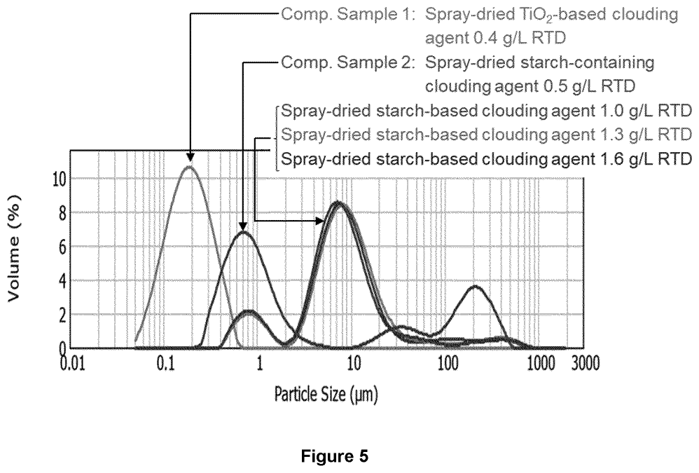

While the particle size of the spray-dried starch-based clouding agent is preferably within those ranges, the particle size within the corresponding initial starch-based clouding emulsion and the final liquid beverage preparation after reconstitution with water or other suitable liquids, respectively, i.e. the oil droplet size, ranges between 1 μm and 10 μm, preferably between 4 μm and 10 μm and even more referred between 5 μm and 10 μm (FIGS. 1 and 5).

Interestingly, it was found that the oil droplet size within the final liquid beverage preparation is nearly the same as within the initial starch-based clouding emulsion, indicating that the formed fine and discrete oil particles within the emulsion do not accumulate upon spray-drying and storage. The initially formed discrete oil droplets are released within the final liquid beverage preparation in a likewise discrete and fine-spread manner. Therefore, it also can be concluded that the powdered agent exhibits a high storage stability and that the storage does not influence the clouding properties of the agent.

Particle sizes within these ranges thus allow for a homogeneous, instantaneous and fine distribution of the oil droplets within the final liquid beverage product without accumulation and/or sedimentation, thus resulting in a homogenous and relatively intense opalescence and turbidity. Moreover, when the particle sizes are within these ranges, relatively high stabilities within the final liquid beverage product after reconstitution up to the consumption and thus for a duration of at least 24 hours can be guaranteed by preventing the cloudifying particles to float on top of the beverage or sediment at the bottom thereof.

Thereby, it has been observed, that bigger particle sizes result in decreasing clouding efficiencies, i.e. the turbidity decreases with increasing particle sizes within the final fluid beverage product upon reconstitution with water (as ready-to-drink (RTD) beverage preparation) as bigger oil droplets tend to float on the surface of the beverage preparation, while too small particle sizes do not create a natural and authentic fruit juice-like mouthfeel and appearance. Moreover, particle sizes bigger than 30 μm tend to cause a rather unnatural mouthfeel which is often perceived as sandy.

However, if the particle size of the starch-based clouding emulsion falls within the above range, a homogeneous, finely spread and thus discrete release of the oil droplets into the fluid beverage preparation can be achieved when reconstituted with water even after spray-drying and storage. Furthermore, no additional weighting agents or emulsifiers are required in order to achieve a homogeneous and stable oil-droplet distribution within the aqueous matrix of the final beverage preparation.

Moreover, it was found that both, the particle sizes as well as the relative proportions of the single components of the inventive cloudifier, contribute to the high stability of the powdered product and its high clouding efficiency.

However, if the particle size of the clouding emulsion according to the invention is within the rages defined above, the texture and appearance of the instantly prepared beverage preparation or low-fruit juice content beverage containing the spray-dried clouding agent can be optimized in order to resemble natural fresh pressed fruit juices by making these beverage preparations appear more natural, i.e. authentic and more appealing without negatively influencing the taste and odor of the beverage preparation.

FIG. 4 visualizes the relationship between turbidity and oil droplet size (clouding effect): With increasing droplet size, the turbidity and thus the clouding efficiency decreases exponentially. The turbidity of a transparent liquid is generally a subjective optical impression, which is caused by small particles within the liquid having a different refractive index than the surrounding matrix or due to absorption. Generally, the turbidity of a liquid can be optically determined with a transparent container having a scale on its back side. The number that is just legible through the liquid defines the turbidity of said liquid so that based on the identified number the turbidity of different preparations can be compared.

The person skilled is aware that clouding agents containing titanium dioxide achieve higher degrees of turbidity due to the extraordinary properties of the pigment contained therein. Consequently, generally a lower amount of the pigment-based cloudifier needs to be added to achieve relatively intense cloudiness. However, as indicated above, TiO₂-based products are becoming increasingly unpopular among consumers.

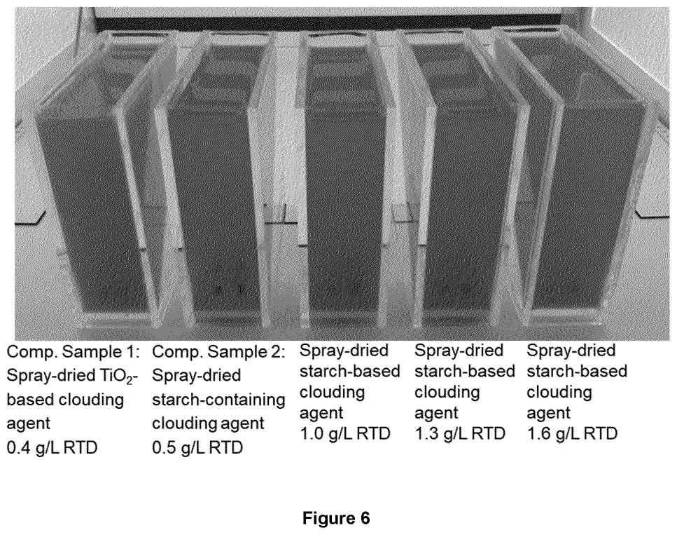

However, a visual comparisons between ready-to drink preparations containing the spray-dried starch-based clouding agent according to the invention as well as standard TiO₂-based clouding products shows that the spray-dried starch-based clouding agents are highly efficient, resulting in comparable turbidites, however, not rising any health concerns. Although the concentration of the inventive spray-dried starch-based clouding agent required in order to achieve a comparable turbidity is slightly higher, no negative influence on the stability, taste, color or mouthfeel of the beverage preparation could be observed (see FIG. 6).

This observation was confirmed by standardized turbidity measurements: In order to standardize the measurement a formazine-based standard was developed allowing to express the corresponding relative turbidity in different units such as FAU (Formazine Attenuation Units; referring to the measurement of transmitted light at an angle of 0° according to ISO 7027) by using a so-called turbidimeter in reference to said formazine standard. The inventive clouding agent achieves a turbidity comparable to the one obtained when using TiO₂-based clouding agents (Table 5, experimental section).

As it was surprisingly found that the starch-based clouding emulsions and the spray-dried starch-based clouding agent according to the invention are highly stable and efficient clouding tools which are based on fully natural, unprocessed and harmless ingredients, the above compositions can be effectively employed in food industry and particular in beverage industry as efficient, cheap and harmless alternative to E 171.

Therefore, the present invention refers to the use of the starch-based clouding emulsion or the spray-dried starch-based clouding agent for the preparation of dry beverage mixtures or fluid beverages.

Thereby, it was found that the clouding emulsion as well as the powdered spray-dried clouding agent can be effectively added to a fluid beverage. However, preferably the spray-dried clouding agent is added to a dry beverage mixture/formulation which can be reconstituted with water in order to form an instantly prepared fluid beverage preparation ready to drink, i.e. the dry beverage mixture is converted into the final cloudy beverage by addition of water, in order to achieve a clouding effect closely resembling the sensory and visual properties of fresh natural fruit juices.

Hereby, a dry beverage mixture or formulation is a powdered mixture of different ingredients making up an instant or artificial beverage preparation such as flavorings such as fruit flavors of orange, lemon, lime and the like, colorants, sugars such as sucrose and the like and other beverage additives, which upon addition of water form an instantly prepared fluid beverage preparation, a so called ready-to-drink beverage preparation (RTD) or instant beverage preparation ready for consumption.

Consequently, in a further aspect, the present invention refers to dry beverage mixtures or fluid beverages or beverage preparations comprising a starch-based clouding emulsion or spray-dried starch-based clouding agent according to the invention.

In addition, the starch-based clouding emulsion or spray-dried starch-based clouding agent can efficiently be incorporated into the formulations of chewing gums, marshmallows, toothpaste, dietary supplements, effervescent tablets, sun creams or the like and other suitable formulations which require substitution of TiO₂.

Hereby, it is preferred that the clouding agent according to the invention has an average particle size of 1 to 10 μm, and preferably an average particle size between 4 μm and 10 μm and even more preferred between 5 μm and 10 μm within the fluid beverage (preparation) to achieve a homogenous and intense opacity and turbidity.

Surprisingly, the starch-based clouding emulsion or spray-dried starch-based clouding agent is especially effective and stable up to consumption and at least for 24 hours when the particle size of the cloudifier lies within the above defined range.

It was further found that the inventive clouding agent allows for achieving a high degree of cloudiness. For example, it was possible to achieve a turbidity of 1135 FAU when incorporating 1 g/L of the spray-dried starch-based clouding agent into a ready-to-drink beverage preparation.

Therefore, in a preferred variant a fluid beverage comprising a starch-based clouding emulsion or spray-dried starch-based clouding agent according to the invention in a concentration of 1 g/L is addressed, wherein the turbidity of the final beverage preparation measured in FAU is 1135.

Generally, the starch-based clouding emulsion and preferably the spray-dried starch-based clouding agent is added to the beverage formulation in amounts effective to achieve the desired clouding effect. However, the amount primarily depends on the desired degree of cloudiness. The spray-dried starch-based clouding agent is added to dry beverage mixtures preferably in amounts of 0.2 wt.-% to 25 wt.-%, preferably from 0.2 wt.-% to 20 wt.-%, even more preferred from 0.2 wt.-% to 15 wt.-% relative to the total amount of the dry beverage mixture in order to provide for a stable and intense cloudiness in the fluid beverage prepared from said dry beverage mixture.

Intense opacities and turbidities are achieved even at low concentrations of the clouding emulsion or the corresponding powdered clouding agent contained in the final beverage product enhancing their natural and more authentic fruit juice-like appearance, texture and mouthfeel closely resembling those of natural fruit juices. Consequently, the present inventions describes an effective and cheap clouding agent capable of achieving a high level of cloudiness even when used in small amounts, ensuring a high storage stability up to two years due to a reduced gum and oil portion, without rising any health concerns based on the incorporation of natural, preferably unprocessed ingredients and the absence of TiO₂.

### EXAMPLES

### Example 1: Starch-Based Clouding Emulsion and Spray-Dried Starch Based Clouding Agent According to the Present Invention

The spray-dried starch based clouding agent according to the invention was prepared by spray-drying a corresponding starch-based clouding emulsion (oil-in-water emulsion).

In the emulsion preparation process, an oil-in-water emulsion was essentially formed by providing an aqueous phase by subsequently adding, mixing and dissolving 35 wt.-% a water-dispersible starch-component and 5 wt.-% of a water-soluble gum-component in water based on the total weight of the resulting starch-based clouding emulsion in a first step. Therefore, an Ystrals Conti-TDS system was supplied with 640 kg of water at room temperature to prepare 1 000 kg of a starch-based clouding emulsion. While stirring at 1 000 rpm native rice starch (350 kg) was carefully added and mixed in for approximately 30 minutes. Thereafter, gum arabic (type seyal; 5 kg) was added to the mixture and stirred until the gum-component was fully dissolve and a homogenous solution obtained, forming the aqueous phase of the oil-in-water emulsion. Subsequently, the stirring speed was increased up to 2 000 rpm, and vegetable oil (MCT, 5 kg) was dispersed in the solution over a period of 15 minutes. During the whole process the temperature of the mixture was kept below 50° C. (see Table 1).

TABLE 1
Formulation of a starch-based clouding
emulsion according to the invention.

| Ingredient | Amount [g] |
|---|---|
| Gum arabic (type seyal) | 5.00 |
| Vegetable oil, MCT | 5.00 |
| Starch (rice; native) | 350.00 |
| Water | 640.00 |
| Total [g] | 1000.00 |

The viscosity of the resulting oil-in-water emulsion was approximately 150 mPa·s. The droplet size of the emulsion is adapted using a simple dispersing device such as an agitator, the shear forces of the dispersing method affect the droplet size of the emulsion.

FIG. 1 shows the droplet or particle size distribution of the oil-in-water emulsion (i.e. the starch based clouding emulsion) according to the present invention. In the characterization process based on laser light diffraction, the distribution of particle sizes was determined by measuring the intensity of light scattered through the sample using a Mastersizer 3000 (produced by Malvern). Thereby, laser light is scattered by the finely dispersed particles, and detectors record the intensity of the light over a wide angular range. In the present case, the finely dispersed particles of the starch-based clouding emulsion have an average particle size of approximately 6 μm as shown in FIG. 1.

Subsequently, the stirring rate was then reduced to 700 rpm and the as-prepared oil-in-water emulsion spray-dried in order to obtain a powdered spray-dried starch-based clouding agent having a water content of below 5 wt. %, preferably while simultaneously mixing in order to achieve a homogenous particle distribution without agglomeration or sedimentation. Spray-drying was carried out with standard equipment and an inlet air temperature of 180° C. to 200° C. and an outlet air temperature of 80° C. to 100° C. The resulting powdered spray-dried starch-based clouding agent has an average particle size of approximately 78 μm (FIG. 3).

The stability of the powdered clouding agent was tested using an accelerated test procedure within a gas-temperature reaction chamber. Thereby the samples were exposed to pressure and oxygen over a defined period of time and then tested against samples that were not stressed. The tested samples show no abnormalities or changes in taste, color, or clouding efficiency after a simulated storage period of two years, thus guaranteeing sufficient storage stability of the product at the customer's site. Neither a phase separation, oxidation nor clumping of the powdered product were observed upon applying said stress test.

The stressed samples also showed no quality deterioration in terms of appearance, color, taste, or clouding efficiency in ready-to-drink fluid beverage preparations upon reconstitution with water.

### Example 2: Formulation of a Dry Beverage Mixture Containing the Spray-Dried Starch-Based Clouding Agent (Dosage of the Clouding Agent: 1.0 g/L RTD-Preparation)

In Example 2 first a dry beverage mixture containing the spray-dried starch-based clouding agent according to the invention (Example 1), is described. The formulation of the dry beverage mixture is given in Table 2 below:

TABLE 2
Formulation of a dry beverage mixture containing the spray-dried
starch-based clouding agent according to the invention.

| Dry beverage mixture | Amount [g] |
|---|---|
| Cellulose (CMC type; CRT 10 000 GA) | 1.00 |
| Xanthan gum | 1.00 |
| Citric acid (anhydrous; fine) | 8.00 |
| Spray-dried starch-based clouding agent | 10.00 |
| according to the invention | |
| Food color “Carotene beta” (1% powder; yellow) | 6.60 |
| Food color “Allura Red” (85%; E129 C.I. 16035) | 0.06 |
| Food color “Sunset yellow” (85%; E110; powder) | 0.04 |
| Sugar (saccharose; extra fine) | 973.30 |
| Total [g] | 1000.00 |

100 g of the final dry beverage formulation containing the cloudifier were reconstituted with 935 ml of water to obtain approximately 1 L of a fluid beverage preparation which is ready-to-drink (RTD). Since this powdered dry beverage mixture already contains sugar and all other ingredients required for the finished beverage preparation, the final beverage preparation has a higher density than 1.000 kg/m³, i.e. 1 000 ml of the final liquid beverage preparation which contains 100 g of the dry beverage mixture according to Table 2 has a density of 1.035 kg/m³.

Consequently, the dosage of the spray-dried starch-based clouding agent was 1.0 g/L RTD-preparation.

It was surprisingly found that the resulting product showed a homogeneous and intense cloudiness closely resembling the appearance of natural fruit juices (orange juice). Moreover, the as-obtained product showed a relatively high stability of at least 24 hours without sedimentation or floating of the cloudifier on the surface of the beverage preparation, i.e. no gravitational phase separation was observed.

### Example 3: Dry Beverage Mixture; Dosage of the Clouding Agent: 1.3 g/L RTD-Preparation

Generally, the spray-dried starch-based clouding agent of Example 1 can be added in different concentrations to various kinds of beverage bases to give a wide range of different dry beverage mixtures.

Example 3 was generally prepared in the same way as Example 2. However, the dosage of the spray-dried starch-based clouding agent was 1.3 g/L RTD-preparation.

### Example 4: Dry Beverage Mixture; Dosage of the Clouding Agent: 1.6 g/L RTD-Preparation

Example 4 was generally prepared in the same way as Example 2. However, the dosage of the spray-dried starch-based clouding agent was 1.6 g/L RTD-preparation.

### Comparative Example 1: Spray-Dried TiO₂-Based Clouding Agent and Dry Beverage Mixture (Dosage of the Clouding Agent: 1.0 g/L RTD-Preparation)

Comparative Example 1 was prepared by emulsifying titanium dioxide, maltodextrin, gum arabic, and xanthan according to Table 3 and subsequent spray-drying the as-obtained emulsion. Thereby, gum arabic, xanthan, maltodextrin and TiO₂ were subsequently dissolved in water. The corresponding particle size distribution is shown in FIG. 2.

TABLE 3
Formulation of a spray-dried TiO₂-based
clouding agent (Comparative Example 1).

| Ingredient | Amount [g] |
|---|---|
| Gum Arabic | 4.70 |
| Titanium dioxide (E 171) | 93.00 |
| Xanthan gum | 2.30 |
| Maltodextrin | 370.00 |
| Water | 530.00 |
| Total [g] | 1000.00 |

By mixing the as obtained clouding agent with the dry beverage base shown in Example 2 a corresponding fluid beverage preparation was prepared, wherein the concentration of the clouding agent is 1.0 g/L of the RTD-preparation: 10 g of the as prepared clouding agent are added to the above described beverage base instead of the inventive spray-dried starch based clouding agent in order to give 1000 g of a corresponding dry beverage mixture. A ready-to-drink instant beverage preparation was obtained by dissolving 100 g of said beverage mixture in water so that the final concentration of the clouding agent is 1.0 g/L RTD-preparation.

### Comparative Example 2: Spray-Dried Starch-Containing Clouding Agent and Dry Beverage Mixture (Dosage of the Clouding Agent: 0.5 g/L and 1.0 g/L RTD-Preparation)

Comparative Example 2 describes spray-dried starch-containing clouding agent based on dextrose, gum arabic and terpins, additionally containing a weighting agent.

The spray-dried starch-containing clouding agent was prepared according to the formulation given in Table 4 and by spry drying the resulting emulsion. To provide the aqueous phase, dextrose and gum arabic were fully dissolved in water using a rotor-stator-stirrer, while the oil phase was obtained by dissolving the weighting agent in terpins. When all solids were completely dissolved, the oil phase was stirred into the water phase and the as-obtained emulsion spray-dried to obtain a powdered clouding agent.

TABLE 4
Formulation of a spray-dried starch-containing
clouding agent (Comparative Example 2).

| Ingredients | Amount [g] |
|---|---|
| Dextrose Monohydrate | 7.30 |
| Gum Arabic | 13.00 |
| Weighting Agent | 2.50 |
| Terpins | 2.30 |
| Water | 74.90 |
| Total in [g] | 100.00 |

By mixing the as obtained clouding agent with the dry beverage base analogously as in Example 2 a fluid beverage preparation was prepared, wherein the concentration of the clouding agent is 0.5 g/L or 1.0 g/L of the RTD-preparation, respectively.

### Experimental Evaluation

FIG. 5 shows a comparison of the particle size distribution of spray-dried starch-based clouding agents in different concentrations (Examples 2 to 4) in comparison with Comparative Examples 1 and 2 each in ready to drink (RTD) beverage preparations as indicated above, i.e. after reconstitution of the corresponding dry beverage mixtures in water. Although the concentration of the inventive spray-dried starch-based clouding agent required to achieve a comparable turbidity is slightly higher, no negative influence on the stability, texture, taste, color, or mouthfeel of the beverage preparation could be observed. The substantially TiO₂-free and starch-containing clouding agent results in significantly smaller particles in the ready-to-drink beverage preparation. Consequently, according to the relationship shown in FIG. 4 significantly weaker turbidity values are to be expected for the present invention when using the same concentrations.

However, FIG. 6 shows a comparison of the turbidity of spray-dried starch-based clouding agents in different concentrations (Examples 2 to 4) in comparison with Comparative Examples 1 and 2 each in ready to drink (RTD) beverage preparations: The turbidity of the corresponding beverage preparations was visually determined using a transparent container having a scale on its back side, wherein the number that is just legible through the liquid defines the corresponding turbidity of the ready-to-drink beverage preparation. The optical comparison shows that the inventive clouding agent allows for a more intense and homogeneous cloudiness compared to the starch-containing clouding agent of Comparative Example 2 (at same dosage rates), even though the particle sizes are bigger.

Table 5 is a comparison of the turbidity of spray-dried starch-based clouding agents in different concentrations in comparison with Comparative Examples 1 and 2 each as ready-to-drink (RTD) beverage preparations, wherein the turbidity was determined in reference to a formazine standard and expressed in FAU (Formazine Attenuation Units) referring to the measurement of transmitted light at an angle of 0° according to ISO 7027 and using a turbidimeter (Hach 2100 IS Turbidimeter).

In comparison with beverage preparations containing other starch-containing clouding agents (TiO₂-free, Comparative Example 2) the inventive beverage formulations (Examples 2 to 4) show relatively high turbidities, without requiring an increase in concentration although the inventive clouding agent exhibits a significantly larger particle size when reconstructed with water: While the turbidity caused by a starch-containing clouding agent is 850 FAU, the spray-dried starch-based clouding agent according to the invention achieves a turbidity of 1135 FAU for the same concentration within the beverage preparation.

In addition, the average particle sizes of the cloudifier within the beverage preparation are larger by a factor of 10 compared to starch-containing clouding agents of the state of the art. However, surprisingly, we have now found that the turbidity is significantly better than the turbidity caused by starch-containing clouding agents of the state of the art (see Table 5). Consequently, the use of the same amount of clouding agent results in a significantly better turbidity performance (despite larger oil droplets). This surprising effect can be explained by the special composition according to the first aspect, and especially the relatively high proportion of the starch-based component and the low relative proportion of the gum- and oil-based components.

Furthermore, the resulting ready-to-drink beverage preparations exhibit an appealing appearance and texture without causing a negatively perceived mouthfeel. Moreover, the dried powdered product exhibit high storage stability up to two years, are cheap in production and based on fully natural, organic and unprocessed ingredients meeting the customer's demands in view of sustainability and health aspects.

TABLE 5
Turbidity of spray-dried starch-based clouding agents in different
concentrations in comparison with Comparative Samples 1 and
2 each as ready to drink (RTD) beverage preparations.

| | Comparative | Comparative | Exam- | Exam- | Exam- |
|---|---|---|---|---|---|
| Sample | Example 1 | Example 2 | ple 2 | ple 3 | ple 4 |
| Clouding | Spray-dried | Spray-dried | Spray-dried | | |
| agent | TiO₂-based | starch- | starch-based | | |
| | clouding agent | containing | clouding agent | | |
| | | clouding agent | | | |
| Dosage | 0.4 | 0.5/1.0 | 1.0 | 1.3 | 1.6 |
| [g/L] | | | | | |
| Turbidity | 1276 | 405/850 | 1135 | 1366 | 1579 |
| [FAU] | | | | | |

1. Starch-based clouding emulsion comprising:
(a) 5 wt.-% to 60 wt.-% of a water-dispersible starch-component;
(b) 0.1 wt.-% to 5 wt.-% of a water-soluble gum-component;
(c) 0.1 wt.-% to 5 wt.-% of an oil-based clouding component;
based on the total weight of the starch-based clouding emulsion; and
(d) water totaling the percentages of all ingredients to 100 wt.-%;
wherein the ratio of the starch-component to the gum-component is higher than or equal to 12:1; and
wherein the ratio of the starch-component to the oil-based clouding component is higher than or equal to 12:1.

2. Starch-based clouding emulsion according to claim 1, wherein the water-dispersible starch-component is comprised in an amount of 20 wt. % to 45 wt.-% relative to the total weight of the starch-based clouding emulsion.

3. Starch-based clouding emulsion according to claim 1, wherein the water-dispersible starch-component is native rice starch.

4. Starch-based clouding emulsion according to claim 1, wherein the water-soluble gum-component is comprised in an amount of 0.1 wt.-% to 2.5 wt.-% relative to the total weight of the starch-based clouding emulsion.

5. Starch-based clouding emulsion according to claim 1, wherein the water-soluble gum-component is gum arabic.

6. Starch-based clouding emulsion according to claim 1, wherein the oil-based clouding component is comprised in an amount of 0.1 wt.-% to 2.5 wt.-% relative to the total weight of the starch-based clouding emulsion.

7. Starch-based clouding emulsion according to claim 1, wherein the oil-based clouding component is a vegetable oil.

8. Method for preparing a spray-dried starch-based clouding agent comprising the following steps:
(i) preparation of a starch-based clouding emulsion by:
(i-i) providing an aqueous phase by mixing and dissolving 5 wt.-% to 60 wt.-% of a water-dispersible starch-component and 0.1 wt.-% to 10 wt.-% of a water-soluble gum-component in an aqueous solution, based on the total weight of the starch-based clouding emulsion;
(i-ii) providing 0.1 wt.-% to 10 wt.-% of an oily phase comprising an oil-based clouding component, based on the total weight of the starch-based clouding emulsion; and
(i-iii) emulsifying the aqueous phase and the oily phase to obtain an oil-in-water emulsion; and
(ii) spray-drying the as-prepared oil-in-water emulsion to obtain a powdered spray-dried starch-based clouding agent.

9. Method for preparing a spray-dried starch-based clouding agent according to claim 8, wherein the temperature of the aqueous phase does not exceed 70° C.

10. Spray-dried starch-based clouding agent obtained according to the method as defined by claim 8.

11. Spray-dried starch-based clouding agent according to claim 10 having an average particle size of 10 to 78 μm.

12. A method of using the starch-based clouding emulsion according to claim 1 comprising preparing a dry beverage mixture or a fluid beverage comprising the starch-based clouding emulsion.

13. Dry beverage mixture or fluid beverage comprising a starch-based clouding emulsion according to claim 1.

14. Fluid beverage according to claim 13, wherein the clouding agent has an average particle size of 1 to 10 μm.

15. A spray-dried starch useful as a clouding agent comprising:
(a) 5 to 60 parts by weight of a water-dispersible starch-component;
(b) 0.1 to 5 parts by weight of a water-soluble gum-component; and
(c) 0.1 to 5 parts by weight of an oil-based clouding component;

16. The spray-dried starch of claim 15, wherein the ratio of the starch-component to the gum-component is higher than or equal to 12:1; and
wherein the ratio of the starch-component to the oil-based clouding component is higher than or equal to 12:1.

17. A method of using the spray-dried starch-based clouding agent according to claim 15, comprising preparing a dry beverage mixture or a fluid beverage comprising the spray-dried starch-based clouding agent.

18. A dry beverage mixture or fluid beverage comprising a spray-dried starch-based clouding agent according to claim 15.

19. A dry beverage mixture or fluid beverage comprising a spray-dried starch-based clouding agent according to claim 16.
